(19) United States
(12) Patent Application Publication
(10) Pub. No.: US 2022/0397851 A1
(43) Pub. Date: Dec. 15, 2022

(54) IMAGE FORMING APPARATUS

(71) Applicant: TOSHIBA TEC KABUSHIKI KAISHA, Tokyo (JP)

(72) Inventor: Sunao TAKENAKA, Odawara Kanagawa (JP)

(21) Appl. No.: 17/673,299

(22) Filed: Feb. 16, 2022

(30) Foreign Application Priority Data
Jun. 10, 2021 (JP) 2021-097412

(51) Int. Cl. G03G 15/00

(52) U.S. Cl. CPC G03G 15/5025

(57) ABSTRACT

According to an embodiment, an image forming apparatus performs first image density adjustment by measuring image density of a first test pattern formed using a rotation member. The image forming apparatus forms, where a first variation that is a variation of a predetermined number of image density detection values or adjustment values by the first image density adjustment is a predetermined threshold value or more, a second test pattern on a transfer body using the rotation member, the second test pattern being longer than a peripheral length of the rotation member in a sub-scanning direction.

### CROSS-REFERENCE TO RELATED APPLICATIONS

This application is based upon and claims the benefit of priority from the prior Japanese Patent Application No. 2021-097412, filed on Jun. 10, 2021, the entire contents of which are incorporated herein by reference.

### FIELD

An embodiment to be described here generally relates to an image forming apparatus.

### BACKGROUND

Some image forming apparatuses form a test pattern with toner on a transfer body such as a transfer belt and control the density of a toner image. Such an image forming apparatus adjusts a development bias and the like such that the density of a print image formed from a toner image is appropriate image density.

However, the image forming apparatus causes uneven image density in the traveling direction of a toner image (sub-scanning direction) accompanying the running of the transfer belt in some cases. In such a case, the image forming apparatus cannot appropriately adjust the image density in some cases depending on the position at which the test pattern has been formed.

### BRIEF DESCRIPTION OF THE DRAWINGS

FIG. 1 is a block diagram showing a configuration example of an image forming apparatus according to an embodiment;

FIG. 2 is a diagram showing a configuration example of a formation device of the image forming apparatus according to the embodiment;

FIG. 3 is a diagram showing an example of a first test pattern according to the embodiment;

FIG. 4 is a diagram showing an example of a second test pattern according to the embodiment;

FIG. 5 is a diagram showing an example of image density according to the embodiment;

FIG. 6 is a diagram showing an example of the corrected image density according to the embodiment; and

FIG. 7 is a flowchart showing an example of an operation of the image forming apparatus according to the embodiment.

### DETAILED DESCRIPTION

In accordance with an embodiment, an image forming apparatus includes: a formation device, a sensor, and a processor. The formation device includes a rotation member for forming a toner image and forms the toner image on a transfer body. The sensor measures image density of the toner image formed on the transfer body. The processor forms a first test pattern on the transfer body using the rotation member. The processor measures image density of the first test pattern using the sensor. The processor performs first image density adjustment for setting an adjustment value for adjusting the image density of the toner image on the basis of an image density detection value obtained by measuring the image density of the first test pattern. The processor calculates, upon performing the first image density adjustment a predetermined number of times, a first variation that is a variation of a predetermined number of the image density detection values or the adjustment values. The processor forms, where the first variation is a predetermined threshold value or more, a second test pattern on the transfer body using the rotation member, the second test pattern being longer than a peripheral length of the rotation member in a sub-scanning direction.

Hereinafter, an embodiment will be described with reference to the drawings. In the drawings, the same reference symbols denote the same or similar portions. An image forming apparatus according to an embodiment forms an image on a medium such as paper using toner. The image forming apparatus forms a toner image on a transfer body such as a transfer belt. The image forming apparatus transfers the toner image formed on the transfer body to the medium such as paper. The image forming apparatus heats the medium to which the toner image has been transferred to fix the toner image to the medium.

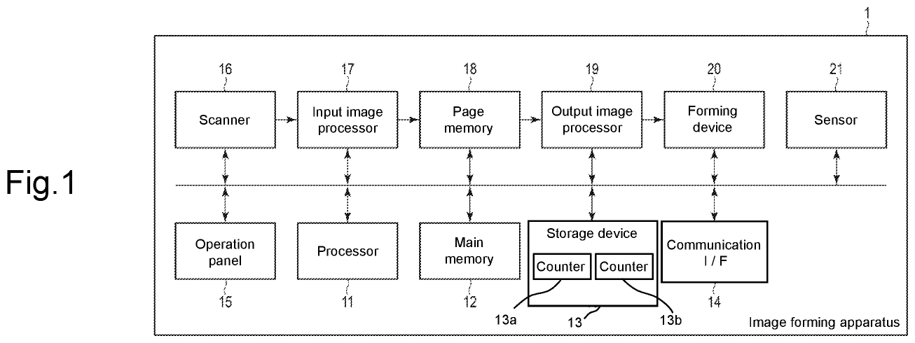

FIG. 1 is a block diagram showing a configuration example of an image forming apparatus 1 according to the embodiment. As shown in FIG. 1, the image forming apparatus 1 includes a processor 11, a main memory 12, a storage device 13, a communication interface 14, an operation panel 15, a scanner 16, an input image processor 17, a page memory 18, an output image processor 19, a formation device 20, a sensor 21, and the like. The respective units are connected to each other via a data bus or the like.

Note that the image forming apparatus 1 may have another configuration as necessary in addition to the configuration shown in FIG. 1, or a specific configuration may be excluded from the image forming apparatus 1.

The processor 11 has a function of controlling the operation of the entire image forming apparatus 1. The processor 11 may include an internal memory, various interfaces, and the like. The processor 11 realizes various types of processing by executing a program stored in the internal memory, the storage device 13, or the like in advance.

Note that some of the various functions realized by the processor 11 executing a program may be realized by a hardware circuit. In this case, the processor 11 controls the function executed by the hardware circuit.

The main memory 12 is a volatile memory. The main memory 12 is a working memory or a buffer memory. The main memory 12 stores various application programs on the basis of an instruction from the processor 11. Further, the main memory may store data necessary for executing an application program, the result of executing the application program, and the like.

The storage device 13 is a non-volatile memory capable of writing and rewriting data. The storage device 13 includes, for example, an HDD (Hard Disk Drive), an SSD (Solid State Drive), or a flash memory. The storage device 13 stores a control program, an application, various types of data, and the like in accordance with the operational use of the image forming apparatus 1.

The operation panel 15 input various instructions by an operator of the image forming apparatus 1. The operation panel 15 outputs a signal indicating the input instruction to the processor 11 by an operation of the operator. The operation panel 15 includes, for example, a keyboard, a numeric key, and a touch panel as operation devices.

Further, the operation panel 15 displays various types of information to the operator of the image forming apparatus 1. That is, the operation panel 15 displays a screen showing various types of information on the basis of the signal from the processor 11. The operation panel 15 includes, for example, a liquid crystal display as a display device.

The scanner 16 optically scans a document to read an image of the document and generates image data. The scanner 16 according to the embodiment reads the image of the document as a color image. The scanner 16 includes a sensor array formed in the main scanning direction. The scanner 16 causes the sensor array to move in the sub-scanning direction and reads the entire document.

The input image processor 17 processes the image data generated by the scanner 16. Note that the input image processor 17 may process image data acquired from other than the scanner 16. For example, the input image processor 17 may process image data transmitted from a USB memory, a PC, or a smartphone.

The page memory 18 stores the image data processed by the input image processor 17. The output image processor 19 processes the image data stored in the page memory 18 so that the formation device 20 is capable of printing an image corresponding to the image data on paper.

The formation device 20 prints an image corresponding to the image data processed by the output image processor 19 on paper on the basis of the control of the processor 11. The formation device 20 prints an image corresponding to the image data by, for example, an electrophotographic method. Further, the formation device 20 includes a transfer body, a roller for driving the transfer body, a photoconductor drum, and the like. The formation device 20 will be described below.

The sensor 21 detects the toner image formed on a transfer body 31 described below of the formation device 20. The sensor 21 detects the density of toner on the transfer body 31. The sensor 21 outputs an image density detection value indicating the image density of toner to the processor 11. The sensor 21 is an optical sensor. For example, an optical sensor that measures the image density of toner by the amount of reflected light is used as the sensor 21. The sensor 21 may include a CCD (Charge Coupled Device) camera. Further, the sensor 21 may include a light or the like that illuminates the transfer body 31.

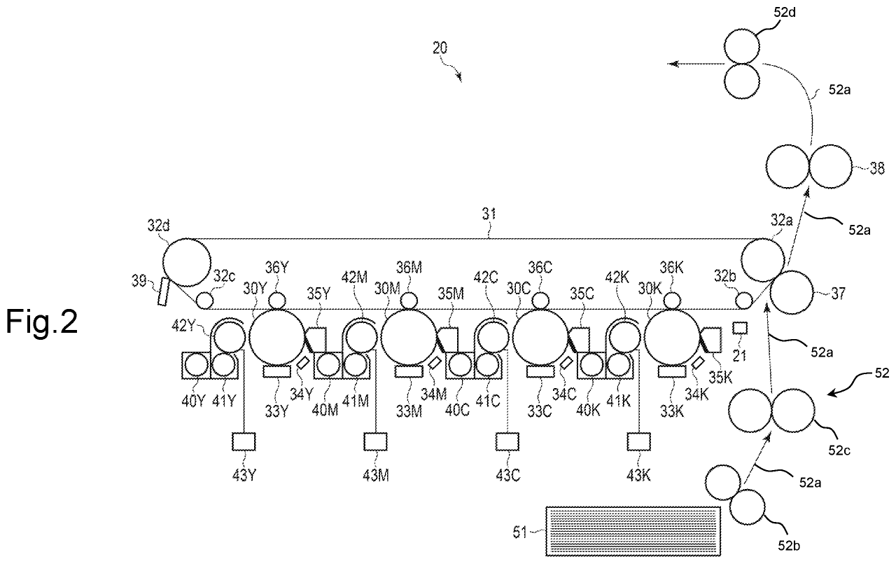

Next, the formation device 20 will be described. FIG. 2 is a diagram showing a configuration example of the formation device 20. As shown in FIG. 2, the formation device 20 includes a photoconductor drum 30, the transfer body 31, a support roller 32, a charging device 33, a static eliminator 34, a photoreceptor cleaner 35, a primary transfer roller 36, a secondary transfer roller 37, a fixing device 38, a transfer body cleaner 39, a developing device 40, a stirring device 41, a developing roller 42, a voltage applying unit 43, a paper cassette 51, a conveying device 52, and the like.

The transfer body 31 is an intermediate transfer body. The transfer body 31 is formed in a belt shape. That is, the transfer body 31 is formed in a ring shape with a predetermined width.

The support roller 32 is a roller for driving the transfer body 31. Each of support rollers 32a to 32d is disposed inside the transfer body 31. Each of the support rollers 32a to 32d supports the transfer body 31 in a planar manner by pulling the transfer body 31 from the inside with predetermined tension.

Each of the support rollers 32a to 32d is caused to rotate by a driving force from a driving device. Each of the support rollers 32a to 32d rotates to cause the transfer body 31 to travel endlessly. Note that some of the support rollers 32a to 32d may be caused to passively rotate.

The formation device 20 includes, for each color of toner, the photoconductor drum 30, the charging device 33, the static eliminator 34, the photoreceptor cleaner 35, the primary transfer roller 36, the developing device 40, the stirring device 41, the developing roller 42, and the voltage applying unit 43. In this example, in order to form a toner image of four colors of cyan (C), magenta (M), yellow (Y), and black (K), the formation device 20 includes the photoconductor drum 30, the charging device 33, the static eliminator 34, the photoreceptor cleaner 35, the primary transfer roller 36, the developing device 40, the stirring device 41, the developing roller 42, and the voltage applying unit 43 for each of the colors. Note that the developing device 40 includes the stirring device 41 and the developing roller 42.

That is, the formation device 20 includes photoconductor drums 30Y, 30M, 30C, and 30K as the photoconductor drum 30. Further, the formation device 20 includes charging devices 33Y, 33M, 33C, and 33K as the charging device 33. Further, the formation device 20 includes static eliminators 34Y, 34M, 34C, and 34K as the static eliminator 34. Further, the formation device 20 includes photoreceptor cleaners 35Y, 35M, 35C, and 35K as the photoreceptor cleaner 35.

Further, the formation device 20 includes primary transfer rollers 36Y, 36M, 36C, and 36K as the primary transfer roller 36. Further, the formation device 20 includes developing devices 40Y, 40M, 40C, and 40K as the developing device 40. Further, the developing device 40 of the formation device 20 includes stirring devices 41Y, 41M, 41C, and 41K as the stirring device 41. Further, the developing device 40 of the formation device 20 includes developing rollers 42Y, 42M, 42C, and 42K as the developing roller 42. Further, the formation device 20 includes voltage applying units 43Y, 43M, 43C, and 43K as the voltage applying unit 43.

In this example, the photoconductor drum 30K, the charging device 33K, the static eliminator 34K, the photoreceptor cleaner 35K, the primary transfer roller 36K, the developing device 40K, the stirring device 41K, the developing roller 42K, and the voltage applying unit 43K will be described as representatives.

The developing device 40K is a container that houses a developer containing toner and carrier particles having magnetism. The developing device 40K receives toner fed from a toner cartridge. The developer is housed in the developing device 40K at the time of production, at the start of use, or the like.

The stirring device 41K is provided in the developing device 40K. The stirring device 41K stirs the developer in the developing device 40K. The stirring device 41K includes a screw for stirring the developer, a motor that causes the screw to rotate, and the like.

Further, the developing roller 42K is provided in the developing device 40K. The developing roller 42K attract the developer by a built-in magnet (not shown) and rotates in the developing device 40 to attach the developer to the surface thereof. The developing roller 42K is caused to rotate by a motor or the like. The developing roller 42K is one of rotation members for forming a toner image on the transfer body 31.

The voltage applying unit 43K applies a development bias to the developing roller 42K in accordance with the control of the processor 11. The toner of the developer attached to the developing roller 42K is attached to the photoconductor drum 30K by the electric field generated by the development bias to develop an electrostatic latent image, and thus, a toner image is formed on the photoconductor drum 30K.

The photoconductor drum 30K is a photoconductor including a cylindrical drum and a photosensitive layer formed on the outer peripheral surface of the drum. The photoconductor drum 30K rotates at a constant speed by the power transmitted from a motor. The photoconductor drum 30K is one of rotation members for forming a toner image on the transfer body 31. The charging device 33K uniformly charges the surface of the photoconductor drum 30K.

The photoconductor drum 30K is irradiated with a laser modulated in accordance with the image data from an exposure device (not shown), in the charged state while rotating. As a result, an electrostatic latent image corresponding to the image data is formed on the photoconductor drum 30K by the laser irradiation.

The primary transfer roller 36K is formed at a position facing the photoconductor drum 30K with the transfer body 31 sandwiched therebetween. The primary transfer roller 36K causes the transfer body 31 to come into contact with the photoconductor drum 30K. The primary transfer roller 36K transfers the toner image formed on the photoconductor drum 30K to the transfer body 31. The primary transfer roller 36K is one of rotation members for forming a toner image on the transfer body 31.

The photoreceptor cleaner 35K includes a blade or the like that comes into contact with the surface of the photoconductor drum 30K. The photoreceptor cleaner 35K removes the toner remaining on the surface of the photoconductor drum 30K using the blade. The static eliminator 34K removes the charges of the photoconductor drum 30K.

The sensor 21 is disposed downstream of the primary transfer roller 36. Note that the downstream means the downstream in the direction in which the transfer body 31 travels. That is, the sensor 21 measures the image density of each of toner images transferred by the respective primary transfer rollers 36.

The paper cassette 51 is a cassette that houses paper as a medium. The paper cassette 51 has a structure in which paper can be supplied from the outside of the casing of the image forming apparatus 1. For example, the paper cassette 51 has a structure that can be pulled out from the casing.

The conveying device 52 conveys paper along a conveying path 52a. For example, the conveying device 52 includes a paper feed roller 52b provided in the vicinity of the paper cassette 51, a conveying roller 52c provided along the conveying path 52a, and a paper ejection roller 52d provided in the vicinity of an ejection port (not shown) of the image forming apparatus 1. The paper feed roller 52b of the conveying device 52 takes out paper one by one from the paper cassette 51. The conveying roller 52c of the conveying device 52 conveys the taken out paper to the secondary transfer roller 37 along the conveying path 52a. The paper ejection roller 52d of the conveying device 52 ejects the paper after fixing, which will be described below, to the outside of the image forming apparatus 1. For example, the conveying device 52 may include a conveying belt.

The secondary transfer roller 37 transfers the toner image formed on the transfer body 31 to paper. As shown in FIG. 2, the secondary transfer roller 37 is disposed at a position facing the support roller 32a with the transfer body 31 sandwiched therebetween. The secondary transfer roller 37 transfers the toner image on the transfer body 31 to the paper conveyed by the conveying device 52.

The fixing device 38 is provided downstream of the secondary transfer roller 37 in the conveying direction of paper. The fixing device 38 fixes the toner image transferred to paper to the paper. The fixing device 38 heats the toner image to a fixing temperature to fix the toner image to the paper. For example, the fixing device 38 includes a heater and the like.

The transfer body cleaner 39 includes a blade or the like that comes into contact with the surface of the transfer body 31. The transfer body cleaner 39 removes the toner remaining on the surface of the transfer body 31 using the blade. The paper ejection roller 52d of the conveying device 52 ejects the paper to which the toner image has been fixed to the outside of the image forming apparatus 1.

As described above, the formation device 20 formed a toner image on the transfer body 31. The formation device 20 transfers the toner image formed on the transfer body 31 to paper using the secondary transfer roller 37. The formation device 20 heats the paper to which the toner image has been transferred to fix the toner image to the paper using the fixing device 38. The formation device 20 ejects the paper to which the toner image has been fixed to the outside using the conveying device 52.

Next, the function realized by the image forming apparatus 1 will be described. The function realized by the image forming apparatus 1 is realized by the processor 11 executing a program stored in the storage device 13 or the like.

First, the processor 11 has a function of controlling the respective units of the image forming apparatus 1 in order to print an image on paper using toner. For example, an operator of the image forming apparatus 1 sets a document on the scanner 16. The processor 11 drives the scanner 16. The scanner 16 generates image data of the set document. The processor 11 acquires the image data output from the scanner 16. Note that the processor 11 may acquire image data from an external apparatus via the communication interface (I/F) 14.

Further, the processor 11 applies a development bias to the developing roller 42 using the voltage applying unit 43. Further, the processor 11 causes the developing roller 42 to rotate.

Further, the processor 11 causes the photoconductor drum 30 to rotate. The photoconductor drum 30 is charged to a predetermined potential by the charging device 33. The exposure device irradiates the photoconductor drum 30 with a laser on the basis of the control of the processor 11. In the photoconductor drum 30, the potential of the region irradiated with a laser changes. An electrostatic latent image is formed on the surface of the photoconductor drum 30 by the change in potential.

The toner of the developer attached to the developing roller 42 moves to the photoconductor drum 30 due to the development bias applied to the developing roller 42. The electrostatic latent image on the surface of the photoconductor drum 30 is developed by the movement of the toner of the developer attached to the developing roller 42 to the photoconductor drum 30. That is, a toner image is formed on the surface of the photoconductor drum 30.

The toner image formed on the surface of the photoconductor drum 30 is transferred onto the transfer body 31 by the primary transfer roller 36 facing the photoconductor drum 30. After the transfer, part of the toner contained in the toner image remains on the photoconductor drum 30 without being transferred to the transfer body 31.

The photoreceptor cleaner 35 removes the toner remaining on the photoconductor drum 30 from the photoconductor drum 30.

Further, the processor 11 controls the respective units such that the tonner images formed on the respective photoconductor drums 30 overlap with each other and are transferred to the transfer body 31.

When a toner image is transferred to the transfer body 31, the processor 11 takes out paper from the paper cassette 51 using the conveying device 52. When the paper is taken out, the processor 11 conveys the paper to a position between the transfer body 31 and the secondary transfer roller 37 using the conveying device 52. That is, the processor 11 controls the conveying device 52 and the like in order to transfer the toner image formed on the transfer body 31 to the paper.

For example, a voltage (bias) is applied between the secondary transfer roller 37 and the support roller 32a. For this reason, an electric field is generated between the secondary transfer roller 37 and the support roller 32a. The toner image formed on the transfer body 31 is transferred to the paper by this electric field.

When the toner image is transferred to the paper, the processor 11 conveys the paper to which the toner image has been transferred to the fixing device 38 using the conveying device 52. When the paper is conveyed to the fixing device 38, the processor 11 heats the toner image at a predetermined temperature using the fixing device 38. That is, the fixing device 38 is controlled by the processor 11 to heat the toner image to a temperature at which the toner image is fixed. The toner image is heated and thus fixed to the paper.

When the toner image is fixed to the paper, the processor 11 ejects the paper using the conveying device 52.

The processor 11 counts the number of times an image is printed on paper. In this example, the storage device 13 includes a number-of-prints counter 13a that counts the number of times an image is printed on paper. The processor 11 increment the number-of-prints counter 13a each time an image is printed on paper.

Further, the processor 11 has a function of forming a first test pattern on the transfer body 31 to adjust the image density of a print image (toner image) to be printed on paper by the formation device 20 (first image density adjustment). For example, the processor 11 performs the first image density adjustment each time an image is printed on a predetermined number of (e.g., 1000) sheets of paper. That is, the processor 11 performs the first image density adjustment each time the number-of-prints counter 13a reaches a predetermined value. Note that the processor 11 may perform the first image density adjustment each time a predetermined time elapses or the drive time of the formation device 20 reaches a predetermined value.

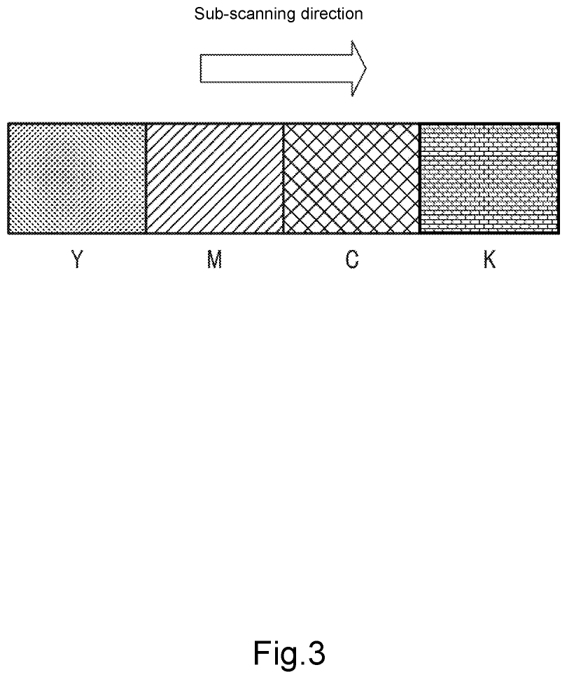

FIG. 3 shows an example of the first test pattern. As shown in FIG. 3, the first test pattern is a solid image of each color having predetermined image density (e.g., the maximum density or intermediate density).

The first test pattern includes solid images of yellow, magenta, cyan, and black in the sub-scanning direction. Each solid image is formed in a rectangular shape.

For example, the processor 11 forms a solid toner image on each photoconductor drum 30 using the toner of each developing device 40. When a solid image is formed on each photoconductor drum 30, the processor 11 transfers the solid image of each photoconductor drum 30 to the transfer body 31 using each primary transfer roller 36 to form a first test pattern on the transfer body 31.

When the first test pattern is formed on the transfer body 31, the processor 11 causes the transfer body 31 to travel. The processor 11 causes the transfer body 31 to travel to cause the first test pattern to move to a position where the sensor 21 is capable of measuring the image density. The processor 11 measures the image density of the solid image of each color of the first test pattern using the sensor 21 while causing the transfer body 31 to travel. In this example, the processor 11 acquires, for each color, a detection value indicating the image density (image density detection value) from the sensor 21.

When the image density of the solid image of each color is measured, the processor 11 determines whether or not each image density detection value matches a predetermined target value. For example, the processor 11 determines whether or not the difference between each image density detection value and the predetermined target value is a predetermined threshold value or less.

When the image density detection value does not match the predetermined target value, the processor 11 adjusts the image density of the toner image of the color corresponding to the image density detection value such that the density of the toner image matches the predetermined target value. In this example, the processor 11 sets or updates the adjustment value for adjusting the image density of the toner image of the color.

The adjustment value is a value for adjusting the image density of a print image to be printed on paper in a predetermined color. That is, the adjustment value is a value for adjusting the image density of a toner image to be formed on the transfer body 31.

For example, the adjustment value is a value for adjusting the development bias to be applied to the developing roller 42. In this case, the adjustment value is a value that is to be added to or integrated with the default voltage value of the development bias. This addition or integration of the adjustment value adjusts the voltage value of the development bias. Further, the adjustment value may be a voltage value of a development bias.

Further, the adjustment value may be a value for adjusting the concentration (weight percent concentration) of toner of the developer stored in the developing device 40. In this case, the adjustment value is a value to be added to or integrated with the default concentration of toner. This addition or integration of the adjustment value adjusts the concentration of the toner of the developer. Further, the adjustment value may be concentration of toner of a developer.

Note that the configuration of the adjustment value is not limited to a specific configuration. The processor 11 sets or updates the adjustment value for each color.

Further, the processor 11 stores, in the storage device 13, the history of image density detection values and adjustment values for each color. Further, the processor 11 counts the number of times the first image density adjustment is performed. For example, the storage device 13 includes a number-of-adjustments counter 13b that counts the number of times the first image density adjustment is performed. The processor 11 increments the number-of-adjustments counter 13b each time the first image density adjustment is performed.

The processor 11 causes the formation device 20 to operate on the basis of the adjustment value in the subsequent print operation. That is, the processor 11 forms a toner image on the transfer body 31 with the image density based on the adjustment value.

Further, the processor 11 has a function of calculating a variation (first variation) of an image density detection value or an adjustment value.

For example, the processor 11 calculates the first variation each time the first image density adjustment is performed a predetermined number of times (e.g., 10 times). That is, the processor 11 calculates the first variation in the case where the number-of-adjustments counter 13b is a predetermined threshold value or more.

The processor 11 acquires the history of image density detection values or adjustment values from the storage device 13. The processor 11 acquires, as the history, a predetermined number of (e.g., 10) image density detection values or adjustment values.

The processor 11 calculates, upon acquiring a predetermined number of image density detection values or adjustment values, a first variation on the basis of the acquired image density detection values or adjustment values. For example, the processor 11 calculates, as the first variation, the variance or standard deviation of the image density detection values or adjustment values. Further, the processor 11 may calculate, as the first variation, a difference between the maximum value and the minimum value of the image density detection value or adjustment value. Note that the method of calculating the first variation by the processor 11 is not limited to a specific method.

The processor 11 calculates the first variation for each color.

The processor 11 has a function of forming a second test pattern on the transfer body 31 on the basis of the first variation and measuring the image density at a plurality of points (positions) in the second test pattern.

The processor 11 determines, upon calculating the first variation, whether or not the first variation of each color is a predetermined threshold value or less. In this example, assumption is made that the first variation of black is larger than the predetermined threshold value.

The processor 11 forms, upon determining that the first variation of black is larger than the predetermined threshold value, a second test pattern of black toner on the transfer body 31 using the formation device 20.

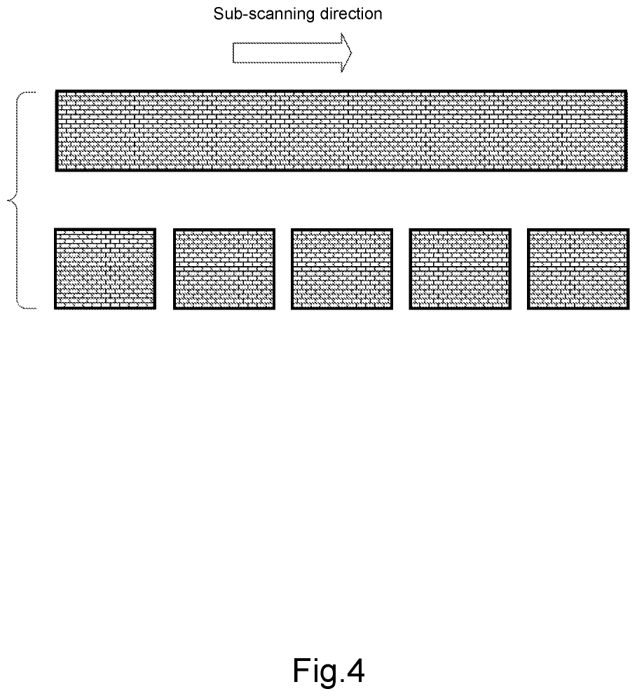

FIG. 4 shows two examples of the second test pattern. As shown in FIG. 4, the second test pattern is a solid image of black having predetermined image density (e.g., the maximum density or intermediate density).

One second test pattern (upper side of FIG. 4) is a solid image having a predetermined length in the sub-scanning direction. The length of the second test pattern in the sub-scanning direction is longer than the peripheral length of the photoconductor drum 30K. In this example, the length of the second test pattern in the sub-scanning direction is longer than twice the peripheral length of the photoconductor drum 30K.

Further, the other second test pattern (lower side of FIG. 4) includes a plurality of solid images arranged in the sub-scanning direction. Similarly, the total length of the second test pattern in the sub-scanning direction is longer than the peripheral length of the photoconductor drum 30K. In this example, the total length of the second test pattern in the sub-scanning direction is longer than twice the peripheral length of the photoconductor drum 30K.

For example, the processor 11 forms a second test pattern on the photoconductor drum 30K using toner (black toner) of the developing device 40K. The processor 11 transfers, upon forming a second test pattern on the photoconductor drum 30K, the second test pattern of the photoconductor drum 30K to the transfer body 31 using the primary transfer roller 36K to form the second test pattern on the transfer body 31.

The processor 11 causes, upon forming the second test pattern on the transfer body 31, the transfer body 31 to rotate. The processor 11 causes the transfer body 31 to rotate to cause the second test pattern to move to a position where the sensor 21 is capable of measuring the image density. The processor 11 measures the image density at a plurality of points (positions) in the second test pattern using the sensor 21 while causing the transfer body 31 to rotate. That is, the processor 11 measures the image density at a plurality of points arranged in the sub-scanning direction. In this example, the processor 11 acquires, from the sensor 21, a detection value indicating the image density (image density detection value).

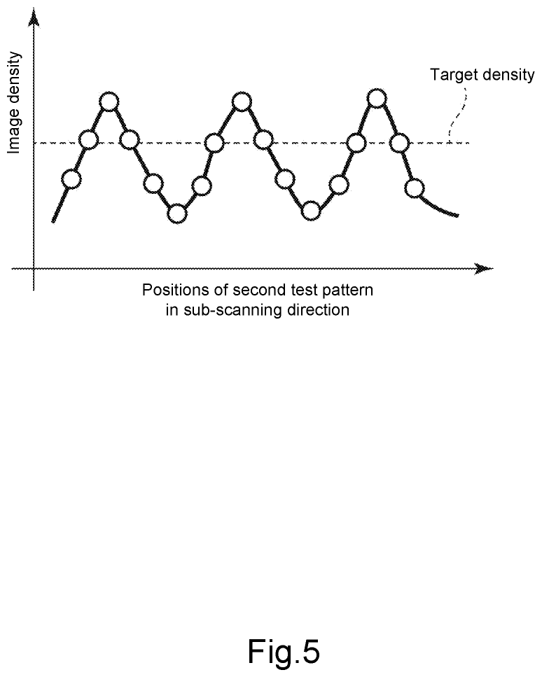

FIG. 5 shows image density detection values at a plurality of points (positions) in the second test pattern. In FIG. 5, the horizontal axis indicates the position of the second test pattern in the sub-scanning direction. Further, the vertical axis indicates the image density detection value (image density).

Further, in FIG. 5, target image density (predetermined target value) is indicated by a broken line. In the example shown in FIG. 5, the image density detection value of the second test pattern oscillates in a predetermined cycle. Further, in this example, assumption is made that the intermediate density of the image density detection value is lower than the target image density. The intermediate density is an average value or median value of image density detection values. Further, the intermediate density may be an intermediate value between the maximum value and the minimum value of the image density detection value.

Further, the processor 11 has a function of calculating a variation (second variation) of image density detection values at a plurality of points (positions) in the second test pattern. The processor 11 calculates, upon acquiring a plurality of image density detection values of the second test pattern, a second variation of the plurality of image density detection values. For example, the processor 11 calculates, as the second variation, the variance or standard deviation of the image density detection values of the second test pattern. Further, the processor 11 may calculate, as the second variation, a difference between the maximum value and the minimum value of the image density detection value of the second test pattern. Note that the method of calculating the second variation by the processor 11 is not limited to a specific method.

Further, the processor 11 has a function of adjusting, on the basis of the image density detection value of the second test pattern, the density of a print image to be printed on paper by the formation device 20 in the case where the second variation is a predetermined threshold value or less (second image density adjustment).

The processor 11 determines, upon calculating the second variation, whether or not the second variation is a predetermined threshold value or less. The processor 11 sets or updates, upon determining that the second variation is the predetermined threshold value or less, the adjustment value (in this example, an adjustment value for black) such that the intermediate density of the second test pattern matches a predetermined target value. Note that the processor 11 does not necessarily need to set or update the adjustment value in the case where the intermediate density of the second test pattern matches the target image density.

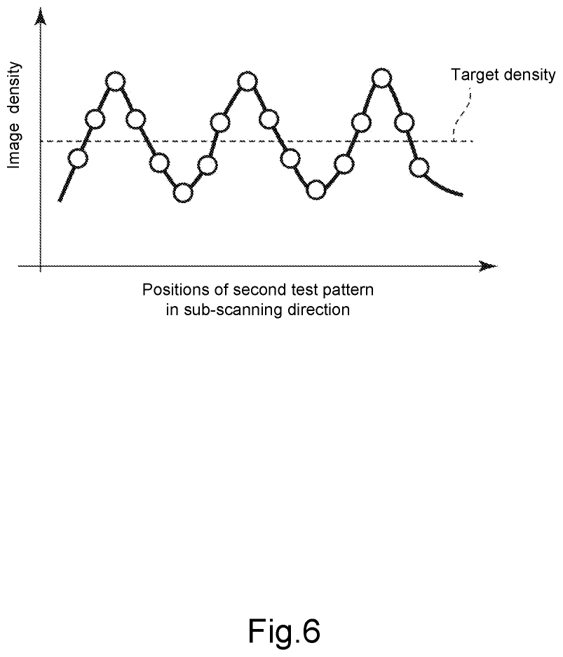

FIG. 6 shows image density detection values at a plurality of pointes (positions) in the second test pattern in the case where the processor 11 has set or updated the adjustment value by the second image density adjustment. In FIG. 6, the horizontal axis indicates positions of the second test pattern in the sub-scanning direction. Further, the vertical direction indicates image density detection values (image density). The second test pattern in FIG. 6, i.e., the second test pattern in the case where the processor 11 has set or updated the adjustment value, does not need to be formed on the transfer body 31. The second test pattern in FIG. 6 may be a second test pattern predicted after setting or updating the adjustment value.

As shown in FIG. 6, the image density detection value of the second test pattern in the case where the processor 11 has set or updated the adjustment value by the second image density adjustment is higher than the image density detection value of the second test pattern in FIG. 5. The intermediate density of the second test pattern in FIG. 6 matches the target image density.

Further, the processor 11 has a function of presenting a failure point in the case where the second variation is larger than a predetermined threshold value.

The processor 11 performs, upon determining that the second variation is larger than the predetermined threshold value, frequency analysis on the plurality of image density detection values of the second test pattern. In this example, the processor 11 performs fast Fourier transformation (FFT).

In the case where any element of the formation device 20 is failed, a peak occurs in the frequency spectrum obtained by frequency analysis. That is, a peak occurs at the frequency corresponding to the failing element. The peak occurs due to an abnormality caused in the second test pattern in a cycle corresponding to the failing element.

For example, in the case where the photoconductor drum 30 is failed, a peak occurs at the rotation frequency of the photoconductor drum 30 or the frequency that is an integral multiple of the rotation frequency. Further, in the case where the developing roller 42 is failed, a peak occurs at the rotation frequency of the developing roller 42, the frequency that is an integral multiple of the rotation frequency, or the like.

Further, the processor 11 measures the image density of the second test pattern at intervals equal to or less than half of the shortest cycle in assumed cycles.

The processor 11 performs frequency analysis to specify the frequency at which a peak occurs in the spectrum. The processor 11 specifies, upon specifying the frequency at which a peak has occurred, an element corresponding to the specified frequency as a failing element. For example, the storage device 13 stores, in advance, a table in which a frequency and an element are associated with each other. The processor 11 refers to the table and specifies the element corresponding to the specified frequency.

The processor 11 displays, upon specifying the failing element, information indicating that the specified element is failed on the operation panel 15.

Note that the processor 11 specifies, in the case where a plurality of frequencies is specified as the frequency at which a peak has occurred, elements corresponding to the frequencies as failing elements. The processor 11 displays information indicating that the plurality of specified elements is failed on the operation panel 15.

Further, the processor 11 may specify a failing element from the spectrum (or an image density detection value of a second test pattern) using a machine learning model (network or the like).

The method of specifying a failing element by the processor 11 is not limited to a specific method.

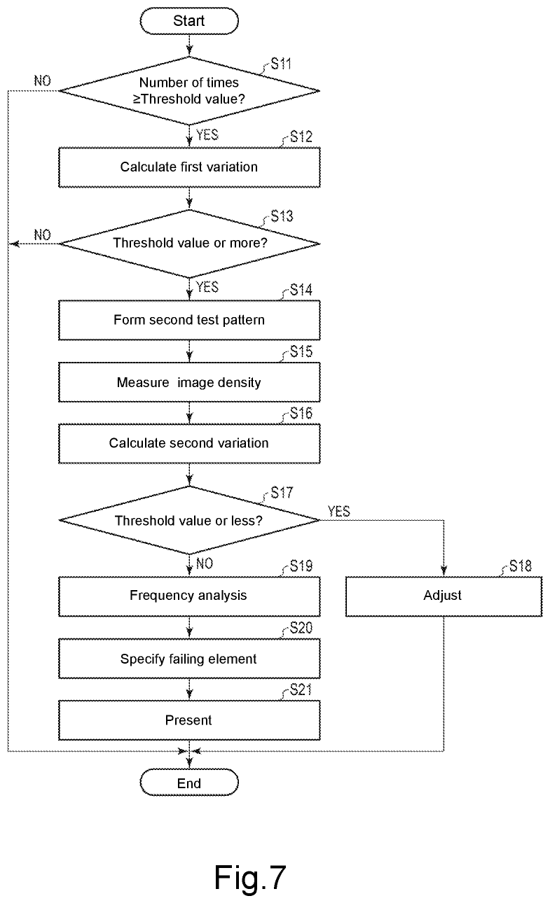

Next, an example of processing performed by the processor 11 of the image forming apparatus 1 will be described. FIG. 7 is a flowchart showing an example of the processing performed by the processor 11 of the image forming apparatus 1.

For example, the processor 11 of the image forming apparatus 1 performs the following processing after performing the first image density adjustment.

First, in Step S11 in FIG. 7, the processor 11 determines whether or not the value of the number-of-adjustments counter 13b is a predetermined threshold value or more. When it is determined that the value of the number-of-adjustments counter 13b is the predetermined threshold value or more (YES in Step S11), the processing of the processor 11 proceeds to Step S12. In Step S12, the processor 11 calculates a first variation from the past image density detection values or adjustment values.

When the first variation is calculated, the processing of the processor 11 proceeds to Step S13. In Step S13, the processor 11 determines whether or not the calculated first variation is a predetermined threshold value or more. When it is determined that the calculated first variation is the predetermined threshold value or more (YES in Step S13), the processing of the processor 11 proceeds to Step S14. In Step S14, the processor 11 forms a second test pattern on the transfer body 31 using the formation device 20.

When the second test pattern is formed on the transfer body 31, the processing of the processor 11 proceeds to Step S15. In Step S15, the processor 11 acquires image density detection values at a plurality of points (positions) in the second test pattern using the sensor 21. When the image density detection values are acquired, the processing of the processor 11 proceeds to Step S16. In Step S16, the processor calculates a second variation from the image density detection values.

When the second variation is calculated, the processing of the processor 11 proceeds to Step S17. In Step S17, the processor 11 determines whether or not the second variation is a predetermined threshold value or less.

When it is determined that the second variation is the predetermined threshold value or less (YES in Step S17), the processing of the processor 11 proceeds to Step S18. In Step S18, the processor 11 sets or updates the adjustment value on the basis of the image density detection value.

When it is determined that the second variation is larger than the predetermined threshold value (NO in Step S17), the processing of the processor 11 proceeds to Step S19. In Step S19, the processor 11 perform frequency analysis on the image density detection value. When the frequency analysis is performed, the processing of the processor 11 proceeds to Step S20. In Step S20, the processor 11 specifies a failing element on the basis of the frequency analysis. When the failing element is specified, the processing of the processor 11 proceeds to Step S21. In Step S21, the processor 11 displays information indicating that the specified element is failed on the operation panel 15.

Meanwhile, in the case where it is determined in Step S11 that the number-of-adjustments counter 13b is less than the predetermined threshold value (NO in Step S11), the processor 11 ends the processing shown in FIG. 7. Further, in the case where it is determined in Step S13 that the calculated first variation is less than the predetermined threshold value (NO in Step S13), the processor 11 ends the processing shown in FIG. 7. Further, in the case where the adjustment value has been set or updated on the basis of the image density detection value (Step S18), the processor 11 ends the processing shown in FIG. 7. Further, in the case where information indicating that the specified element is failed is displayed on the operation panel 15 (Step S21), the processor 11 ends the processing shown in FIG. 7.

Note that the processor 11 may reset, upon ending the processing shown in FIG. 7, the number-of-adjustments counter 13b.

Further, the processor 11 may simulate an adjustment value from the image density detection value of the first test pattern. That is, the processor 11 predicts an adjustment value from the image density detection value of the first test pattern. The processor 11 calculates, upon predicting the adjustment value, a difference between the predicted adjustment value (predicted value) and the currently-set adjustment value. The processor 11 calculated the difference described above similarly each time the first image density adjustment is performed. The processor 11 calculates, upon performing the first image density adjustment a predetermined number of times, a variation of the differences described above. In the case where the variation of the differences described above is a predetermined threshold value or more, the processor 11 performs the second image density adjustment.

Further, in the case where a difference between the predicted value and the currently-set adjustment value is a predetermined threshold value or more, the processor 11 may perform the second image density adjustment.

The above-mentioned image forming apparatus calculates, upon performing first image density adjustment a predetermined number of times, a first variation of image density detection values of a first test pattern. The image forming apparatus forms, in the case where the first variation is a predetermined threshold value or more, a second test pattern on a transfer body, the second test pattern being longer than a peripheral length of a photoconductor drum. The image forming apparatus calculates a second variation from image density detection values at a plurality of points (positions) in a second test pattern. The image forming apparatus sets or updates, in the case where the second variation is a predetermined threshold value or less, an adjustment value on the basis of the image density detection values.

As a result, the image forming apparatus is capable of setting or updating an appropriate adjustment value even in the case where uneven image density is caused in the sub-scanning direction. Further, since the image forming apparatus forms a second test pattern in accordance with a first variation, it is possible to suppress the consumption of toner for adjusting the image density.

Further, the image forming apparatus presents a failing element in the case where the second variation is larger than the predetermined threshold value. As a result, the image forming apparatus is capable of urging an operator to perform repair in the case where it is difficult to adjust image density by the above-mentioned setting or updating of an adjustment value.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a formation device that includes a rotation member for forming a toner image and forms the toner image on a transfer body;
a sensor that measures image density of the toner image formed on the transfer body; and
a processor configured to
form a first test pattern on the transfer body using the rotation member,
measure image density of the first test pattern using the sensor,
perform first image density adjustment for setting an adjustment value for adjusting the image density of the toner image on a basis of an image density detection value obtained by measuring the image density of the first test pattern,
calculate, upon performing the first image density adjustment a predetermined number of times, a first variation that is a variation of a predetermined number of the image density detection values or the adjustment values, and
form, where the first variation is a predetermined threshold value or more, a second test pattern on the transfer body using the rotation member, the second test pattern being longer than a peripheral length of the rotation member in a sub-scanning direction.

2. The image forming apparatus according to claim 1, wherein
the processor measures image density at a plurality of points in the second test pattern using the sensor.

3. The image forming apparatus according to claim 2, wherein
the processor calculates a second variation that is a variation of a plurality of image density detection values obtained by measuring image density at the plurality of points in the second test pattern.

4. The image forming apparatus according to claim 3, wherein
the processor sets, where the second variation is a predetermined threshold value or less, the adjustment value on a basis of the plurality of image density detection values.

5. The image forming apparatus according to claim 2, wherein
the processor sets the adjustment value such that an average value of the plurality of image density detection values is a target image density.

6. The image forming apparatus according to claim 2, wherein
the processor sets the adjustment value such that a median value of the plurality of image density detection values is a target image density.

7. The image forming apparatus according to claim 2, wherein
the processor sets the adjustment value such that an intermediate value between a maximum value and a minimum value of the plurality of image density detection values is a target image density.

8. The image forming apparatus according to claim 4, wherein
the processor performs, where the second variation is larger than the predetermined threshold value, frequency analysis on the plurality of image density detection value.

9. The image forming apparatus according to claim 8, wherein
the processor specifies, on a basis of a result of the frequency analysis, a failing element.

10. The image forming apparatus according to claim 1, wherein
the rotation member is a photoconductor drum.
